(19) United States
(12) Patent Application Publication
(10) Pub. No.: US 2021/0093091 A1
(43) Pub. Date: Apr. 1, 2021

(54) Corner-Locking Block Assembly

(71) Applicant: ATLEISURE LLC, Atlanta, GA (US)

(72) Inventor: Jason Bliss, Atlanta, GA (US)

(73) Assignee: ATLEISURE LLC, Atlanta, GA (US)

(21) Appl. No.: 16/583,373

(22) Filed: Sep. 26, 2019

(51) Int. Cl. A47C 7/28; F16B 7/04; F16B 12/40

(52) U.S. Cl. CPC A47C 7/282; F16B 12/40; F16B 7/0446

(57) ABSTRACT

The present invention relates to interlocking blocks suitable for use at the corners of skeletal frameworks in general and especially at the corners of skeletal frameworks to which rattan mats or other flexible meshes or materials may be attached. Interlocking blocks are disclosed that provide strong and stable corners in skeletal frameworks. Advantageously, rattan or other material may be easily affixed to the interlocking corner blocks while the rattan or other material is slack due to the capability of the interlocking corner blocks to be temporarily disengaged from one another. Tension may then be applied to the attached rattan or other material as the corner blocks are brought into a state of stable and interlocking engagement.

### CROSS REFERENCE

The present application claims the benefit of U.S. design application 29/704,924 filed on Sep. 9, 2019, and also claims priority to the application filed in China on May 21, 2019 and designated as 201920722429.X, each of which is incorporated herein by reference in their entirety.

### BACKGROUND OF THE CURRENT DISCLOSURE

Rattan furniture has traditionally been made by hand weaving rattan strands around a skeletal framework of wood or other material. The hand weaving process typically requires highly skilled labor and long production times. Consequently, machine weaving of natural or artificial rattan mats is becoming increasingly popular. Machine woven mats of rattan, typically rectangular in shape, may be affixed to appropriate skeletal frameworks to produce furniture more cheaply and easily. An example of this process and related skeletal frameworks is given by Li Hongguang in CN105768653(A) (“Rattan weaving structure and rattan chair made by means of same”).

### SUMMARY OF THE CURRENT DISCLOSURE

The present invention relates to interlocking blocks suitable for use at the corners of skeletal frameworks in general and especially at the corners of skeletal frameworks to which rattan mats or other flexible meshes or materials may be attached. Interlocking blocks are disclosed that provide strong and stable corners in skeletal frameworks. Advantageously, rattan or other material may be easily affixed to the interlocking corner blocks while the rattan or other material is slack due to the capability of the interlocking corner blocks to be temporarily disengaged from one another. Tension may then be applied to the attached rattan or other material as the corner blocks are brought back into a state of stable and interlocking engagement.

### BRIEF DESCRIPTION OF THE DRAWINGS

The accompanying drawings illustrate one or more embodiments of the invention and, together with the written description, serve to explain the principles of the invention.

FIG. 1 is a top right front perspective view of a first corner-locking block and a second corner-locking block in an interlocked state.

FIG. 2 is a top right front perspective view of the first corner-locking block alone.

FIG. 3 is a top right front perspective view of the second corner-locking block alone.

FIG. 4 is a top left rear perspective view of the second corner-locking block alone.

FIG. 5 is a right rear top perspective view of a chair with skeletal framework and attached supporting surface using a corner-locking block assembly.

FIG. 6 is a schematic side view of a first slot showing a rattan strand inserted from the side and prevented from escaping upward through the slot due to a rattan knob.

For ease of interpretation, the following reference characters are used: first block 1, first hole 11, raised rim 12, first plug 13, first concavity 131, first slot 14, first slot inner cavity 142, first S-surface 15, first wedge-shelf 16, interlocking recess 17, second block 2, second hole 21, step 22, second plug 23, second concavity 231, second slot 24, second S-surface 25, second wedge-shelf 26, interlocking protrusion 27, supporting surface 3, framework member 4, rattan strand 5, rattan knob 51.

### DETAILED DESCRIPTION OF THE CURRENT DISCLOSURE

The present disclosure will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that when an element is referred to as being “on” another element, it can be directly on the other element or intervening elements may be present there between. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom,” “upper” or “top,” and “left” and “right,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on the “upper” sides of the other elements. The exemplary term “lower” can therefore encompass both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Unless otherwise specifically noted, or clearly apparent to one of ordinary skill, any variations within a particular component or system as set forth herein are believed to be operational in combination with any variations of any other component or system. For example, if a combination of component 1 and component 2 is disclosed, and if component 1 is explicitly disclosed as taking several possible forms 1A, 1B, and 1C, and component 2 is explicitly disclosed as taking several possible forms 2X and 2Y, then all combinations 1A+2X, 1A+2Y, 1B+2X, 1B+2Y, 1C+2X, and 1C+2Y are thereby disclosed.

As used herein, “around,” “about” or “approximately” shall generally mean within 20 percent, preferably within 10 percent, and more preferably within 5 percent of a given value or range. Numerical quantities given herein are approximate, meaning that the term “around,” “about” or “approximately” can be inferred if not expressly stated.

The description will be made as to the embodiments of the present disclosure in conjunction with the accompanying drawings.

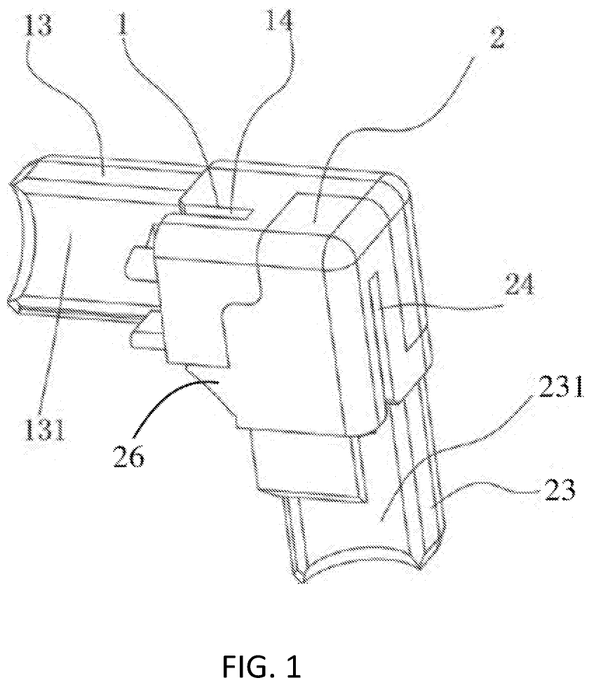

Referring to FIG. 1, a first block 1 is interlocked with a second block 2 in an assembly suitable for use as a strong and stable corner in a skeletal framework. The first block 1 includes several features: a first plug 13 is capable of insertion in a framework member such as a tube or sleeve; the first plug 13 may be characterized as having a concavity 131 so that the plug 13 does not fill the entire interior cross-section of a framework member into which it is inserted; a first slot 14 provides a means for attaching a rattan mat or other material to the first block 1. One of skill in the art will appreciate that unfilled portions of the interior cross-section of a framework member into which a first plug 13 is inserted may have productive uses such as receiving and securing the end(s) of rattan strand(s) or other material that is desired to be attached to a framework member of a skeletal framework.

In practice, a rattan mat or other material may be slid rightward into the slot 14 as depicted in FIG. 1. If the slot 14 has a generously sized interior cavity accessible from the left (not shown in FIG. 1) but a more restricted slot opening as seen on the top of the first block 1, and if the edge of the rattan mat or other material is provided with increased thickness at its lower edge, then it may advantageously result that the mat is easily capable of sliding rightward into the slot 14, but the thickened edge will then prevent the mat from being withdrawn upward from the slot 14. While this is one method of easily securing the edge of a rattan mat or other material within the slot 14, many other methods are also possible. For example, either the slot or the inserted material can be provided with directional barbs to allow downward insertion into the slot 14 but oppose subsequent upward withdrawal of the inserted material. Adhesive or frictional methods could likewise be used.

Continuing to refer to FIG. 1, the second block 2 includes several features: a second plug 23 is capable of insertion in a framework member such as a tube or sleeve; the second plug 23 may be characterized as having a concavity 231 so that the second plug 23 does not fill the entire interior cross-section of a framework member into which it is inserted; a second slot 24 provides a means for attaching a rattan mat or other material to the second block 2; and a second wedge-shelf 26 assists in stabilizing an edge of the first block 1.

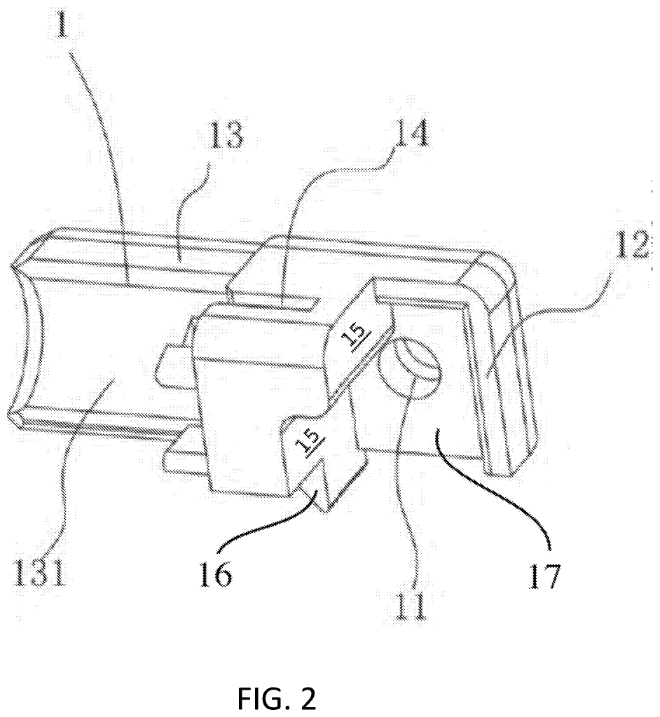

Referring to FIG. 2, the first block 1 is seen alone with the second block 2 having been removed. Additional features of the first block 1 are thus revealed: a raised rim 12; a first S-surface 15; a first wedge-shelf 16; a first hole 11; and an interlocking recess 17.

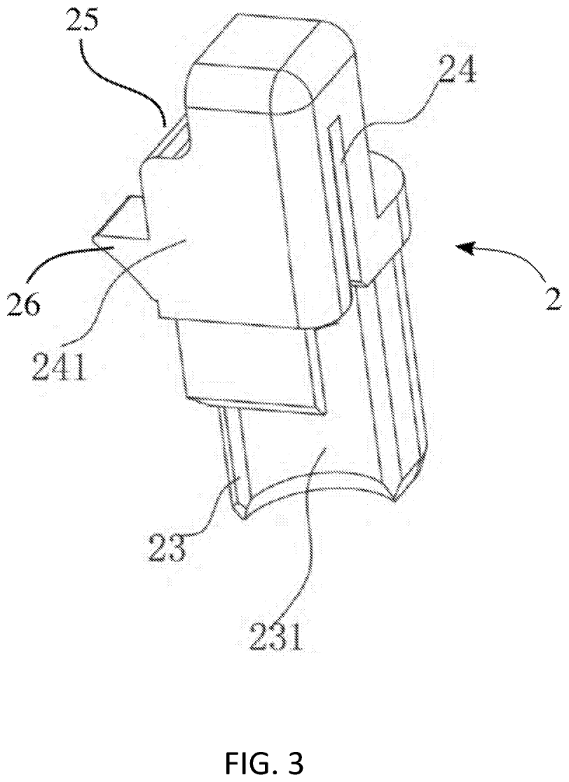

Referring to FIG. 3, the second block 2 is seen alone with the first block 1 having been removed. An additional feature of the second block 2 can be seen more clearly: a second S-surface 25 provides an interlocking counterpart to the first S-surface 15 that was seen in FIG. 2 as a feature of the first block 1.

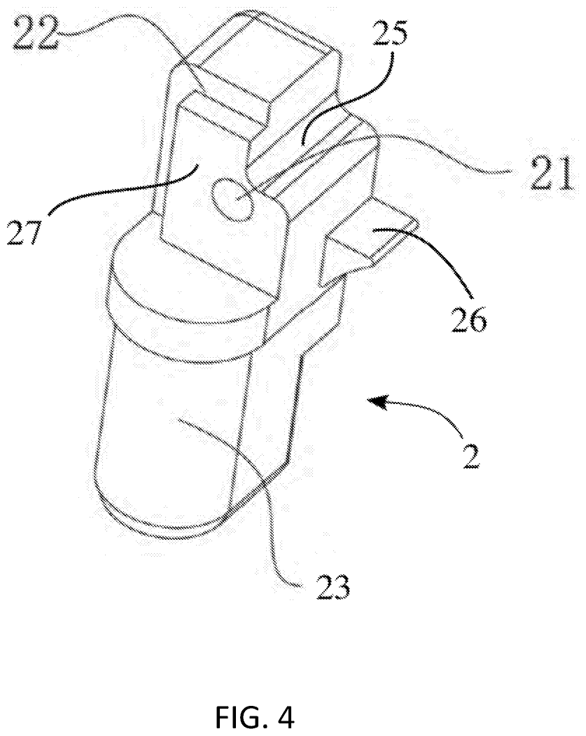

Referring to FIG. 4, the second block 2 is again seen alone, but the point of view has now shifted to the rear, thus revealing additional features of the second block 2: a second hole 21; a peripheral step 22; and an interlocking protrusion 27.

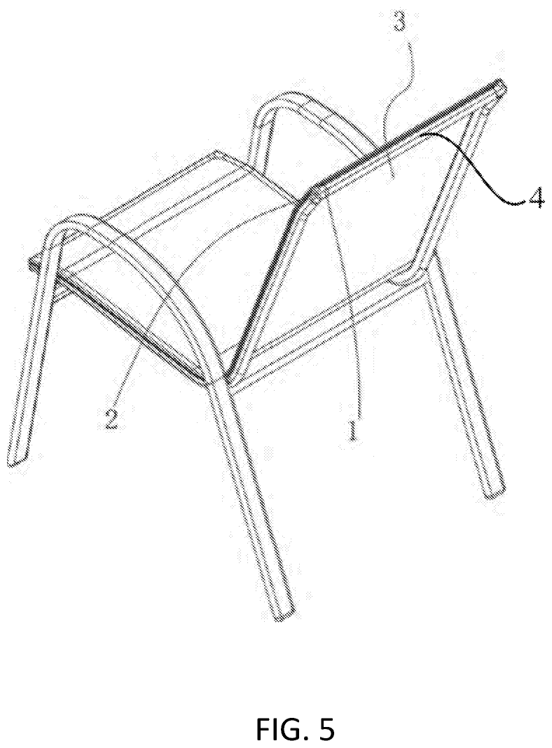

Referring to in FIG. 5, a chair is illustrated with a skeletal framework. A first block 1 and second block 2 are seen at a top corner of the seatback in an interlocked configuration to provide a strong and stable corner to the skeletal framework. Although not indicated in the drawing, additional pairs of matched blocks 1 and 2 could advantageously also be used at the other corners of the skeletal framework. A supporting surface 3 is seen attached to the skeletal framework and could be composed of natural or synthetic rattan, or some other flexible mesh or material. A representative elongated framework member 4 is indicated. Although not illustrated in detail, the first block 1 is joined to the framework member 4 by insertion of the plug 13 (not visible in this view) into the framework member 4.

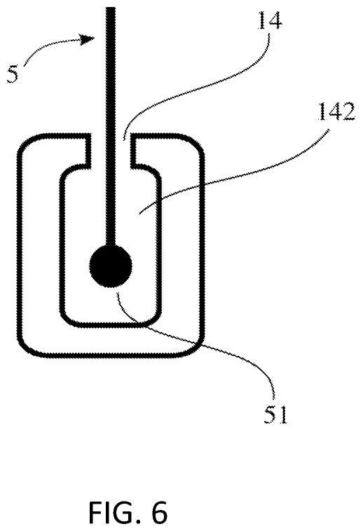

Referring to FIG. 6, a schematic diagram gives a further explanation of how a single rattan strand 5 (or likewise the edge of a machine-woven rattan mat composed of many individual strands) may be secured within a first slot inner cavity 142. The rattan strand 5 with a thicker rattan knob 51 on the end of the strand 5 is inserted into the inner cavity 142 from the side. Insertion from the side avoids any need to pass the rattan knob 51 through the narrow first slot 14. When tension is then applied to the rattan strand 5 in an upward direction, the rattan strand 5 remains securely attached because the rattan knob 5 is too wide to pass upwardly through the first slot 14. This same principle applies to other slots and their associated inner cavities, including for example a second slot 24 and any associated inner cavity.

It will be appreciated by one of skill in the art that the various pairs of interlocking features described are largely independent and may be employed in corner-locking blocks in any combination. Corner-locking blocks of the invention may have all of the pairs of interlocking features: wedge-step interlockable with wedge-step, corner, or plane; S-surface interlockable with S-surface; raised peripheral rim (or raised internal baffle) interlockable with peripheral step (or recessed internal groove); interlocking recess with interlocking protrusion; and hole with aligned hole (with inclusion of a bolt, screw, pin, or other member to bind the holes in relation to one another). However, corner-locking blocks of the invention may omit any combination of the pairs of interlocking features and still function to at least a modest degree.

A peripheral step 22 is disclosed that interlocks with a complementary raised rim 12. While the disclosed step and rim are peripheral and may be described as having an overall “L” shape that is akin to two sides of a rectangle (and includes a right angle change of direction), it is appreciated the peripheral step and complementary raised rim could run merely along a straight line (i.e. a single edge) or be defined as running along any chosen number (1, 2, 3, or 4) of sides of a rectangle or square. Likewise the rim and step could be of irregular shape, or follow a regular curve such as the periphery of a circle, ellipse, or other arc. It is not necessary that any abrupt change of direction of the rim be at 90 degrees.

The S-surfaces disclosed are characterized as a surface that is initially a flat plane and as one progresses along the S-surface it increasingly bends in one direction and then reverses to increasingly bend in an opposite direction before finally ending as a flat plane. An S-surface may also be referred to as an S-wall. For example, the interlocking recess 17 and the interlocking protrusion 27 as shown in the drawings may both be said to be bounded by, or to terminate on one side at, an S-wall.

To aid in aligning and/or locking the first block 1 and the second block 2 together, it will be appreciated that a screw, bolt, pin, or other member may be inserted through hole 11 extending into hole 21. Various means of aligning and fastening may be used including threaded connection, friction, adhesive, or other known means.

Some features may be described as “peripheral”. Unless otherwise noted, this indicates that the feature follows a periphery (outer edge). A peripheral feature need not follow an entire periphery but may sometimes follow only a portion of a periphery. The periphery of a two-dimensional object (or a two-dimensional face of a three-dimensional object) would be a line. The shape of the periphery may sometimes be useful in describing the general shape of a peripheral feature. For example, a peripheral feature that runs along two adjacent sides of a rectangular face might properly be described as generally “L-shaped”.

In describing the shape of an interlocking recess or of a complementary interlocking protrusion, it may be helpful to consider whether the shape can be considered a three-dimensional extrusion of a two-dimensional (i.e., planar) shape. In such a case, one may describe the “planar shape” or “planar form” of the interlocking recess or interlocking protrusion.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to allow others skilled in the art to utilize the invention and various embodiments and with various modifications as are suited to the particular use contemplated. Alternative embodiments will become apparent to those skilled in the art to which the present invention pertains without departing from its spirit and scope.

What is claimed is:

1. An assembly comprising:
a first block and a second block capable of interlocking with one another to form a corner;
said first block provided with a first hole and said second block provided with a second hole such that said first and second holes are aligned when said first and second blocks are interlocked;
said first and second holes capable of accepting a fastening member when aligned; and
said first block provided with a first peripheral raised rim and said second block provided with a peripheral step such that when said first and second blocks are interlocked, said peripheral raised rim resides on said peripheral step.

2. The assembly according to claim 1 wherein:
said first block further comprises a first plug and said first plug has a first concavity;
said first plug is adapted for insertion into a tube, sleeve, or other frame member;
said first block further comprises a first slot; and
said first slot is adapted to accept and retain one or more rattan strands provided with rattan knob(s).

3. The assembly according to claim 2 wherein:
said second block further comprises a second plug and said second plug has a second concavity;
said second plug is adapted for insertion into a tube, sleeve, or other frame member;
said second block further comprises a second slot; and
said second slot is adapted to accept and retain one or more rattan strands provided with rattan knob(s).

4. The assembly according to claim 1 wherein:
said peripheral step and said peripheral rim each extend along the outside of the corner formed when said first block and said second block are interlocked to form a corner.

5. The assembly according to claim 1 wherein:
said first block further comprises a first S-surface;
said second block further comprises a second S-surface; and
said first S-surface and said second S-surface are complementary to one another and are adjoined when said first block and said second block are interlocked to form a corner.

6. The assembly according to claim 1 wherein:
said first block further comprises a first wedge-shelf;
said second block further comprises a second wedge-shelf; and
said first wedge-shelf contacting said second block and said second wedge-shelf contacting said first block when said first block and said second block are interlocked to form a corner.

7. The assembly according to claim 1 wherein:
said first block further comprises an interlocking recess;
said second block further comprises an interlocking protrusion complementary to said interlocking recess;
said interlocking recess bounded on two sides by said peripheral raised rim, bounded by an S-wall on one side, and unbounded on a fourth side;
said interlocking protrusion disposed within said interlocking recess when said first block and said second block are interlocked to form a corner.
